(19) United States
(12) Patent Application Publication
(10) Pub. No.: US 2002/0058442 A1
(43) Pub. Date: May 16, 2002

(54) TWO PIECE MALE ELECTRICAL CONTACT WITH POLARIZER

(76) Inventor: RICHARD P. WALKER, SAEGERTOWN, PA (US)

Correspondence Address: DAVID ROZENBLAT, BRINKS HOFER GILSON & LIONE, P,O, BOX 10395, CHICAGO, IL, 60610, US

(21) Appl. No.: 09/328,739

(22) Filed: Jun. 9, 1999

Related U.S. Application Data
(60) Provisional application No. 60/094,678, filed on Jul. 30, 1998.

(51) Int. Cl. H01R 13/40

(52) U.S. Cl. 439/625

(57) ABSTRACT

A male contact 10 has an elongated contact pin 12 and terminal 24. The contact pin 12 and the terminal 24 extend along a longitudinal axis 14. The contact pin 12 has a first end 16, a second end 18, an upper surface 20 and a lower surface 22 and is quadrangular in cross-section, and in a preferred mode is square in cross-section. The terminal 24 has a first section 26 and a second section 28 spaced therefrom. The first section 26 has a pair of jaws 30, 32, in crimping engagement with the upper contact surface 20. The jaws are attached to a band or ribbon 34 that is in contact with the lower surface 22 of the contact pin 12. A box structure 36 is positioned between the first section 26 and the second section 28 and has an upper surface area 38 and a lower surface area 40. A polarizing key 42 is formed in the lower surface area 40, as by stamping. The key may be formed asymmetrically with respect to the longitudinal axis.

This application claims priority from Provisional Patent Application No. 60/094,678, filed Jul. 30, 1998.

### TECHNICAL FIELD

The present invention relates generally to a male contact that may be connected to a female contact to provide an electrical and mechanical connection between the two. More particularly, the male contact of the present invention is particularly suited as a harness contact in a connector useful in a wiring harness in an automotive electrical system.

### BACKGROUND ART

A typical connector such as a harness connector for use in the automobile industry includes a male harness connector and a female harness connector. Typically, the male harness connector includes a plurality of contact pins and the female harness connector includes a plurality of receptacles in the form of sockets that mate with respective contact pins. In use, the male contact pins are plugged into the female sockets to effect a mechanical and electrical connection between the two. Typically, a plurality of wires such as insulated wires are electrically and mechanically attached to respective contacts of one of the harness connectors such as the contact pins of the male connector. Similarly, a plurality of insulated wires is typically electrically and mechanically attached to respective contacts of the other connector, such as the receptacles of the female connector. The wires may be attached to the respective contacts by crimping and/or welding in a conventional manner.

In such an application there is a need for providing a satisfactory male contact pin which exhibits adequate strength and conductivity. There is also a need for providing a pin terminal that exhibits adequate conductivity, and satisfactory strength and ductility for electrical and mechanical crimped connection between a conductor and the terminal.

One such contact that has met most of these needs is shown in U.S. Pat. No. 5,888,107, issued Mar. 30, 1999 and assigned to the assignee of the present invention. However, this contact requires a long contact pin to extend through a polarizing box and into a crimping area. The extent of the contact pin increases the cost and complexity of manufacture.

Thus, there is a need for providing a contact that is simple and rugged yet polarized to require specific orientation for insertion into a connector body. As the density of the contacts increases, the desirability for polarization also increases. Further, there is a need to reduce the cost and complexity of manufacture by reducing the amount of material needed.

### DISCLOSURE OF INVENTION

It is, therefore, an object of the invention to obviate the disadvantages of the prior art.

It is another object of the invention to enhance male contacts.

Yet another object of the invention is the provision of a simple and inexpensive polarized contact.

A still further object of the invention is the provision of a male contact having a shorter length.

These objects are accomplished, in one aspect of the invention, by a male electrical contact that includes an elongated contact pin having a longitudinal axis and a first end and a second end, and an upper surface and a lower surface. An elongated terminal extends along the longitudinal axis and has a first section attached to the contact pin and a second section spaced therefrom. The first section has a pair of jaws in engagement with the contact upper surface and a band or ribbon engaging the contact lower surface. A box structure lies between the first and second sections and has an upper surface area and a lower surface area. A polarizing key is formed in the lower surface area of the box structure.

Thus, there is provided simple, rugged contact that is economical to manufacture and that has a reduced, compact overall length that reduces the cost and complexity of manufacture.

### BRIEF DESCRIPTION OF THE DRAWINGS

FIG. 1 is a top plan view of an embodiment of the invention;

FIG. 2 is a bottom plan view thereof;

FIG. 3 is a perspective view of an alternate embodiment of the invention from the front and top; and

FIG. 4 is a perspective of the embodiment of FIG. 3 from the rear and bottom.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

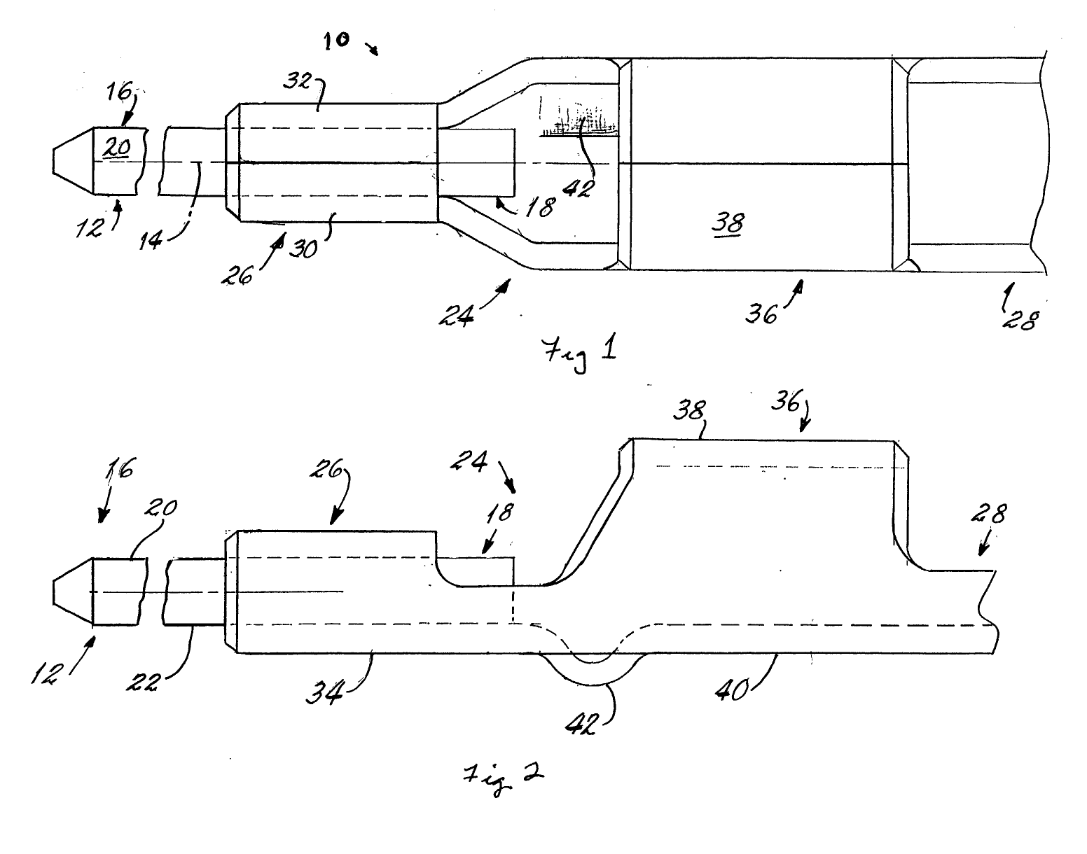

Referring now to the drawings with greater particularity, there is shown in FIG. 1 a male contact in accordance with an aspect of the invention. In particular, there is shown a male contact 10 that comprises an elongated contact pin 12 and terminal 24. The contact pin 12 and the terminal 24 extend along a longitudinal axis 14. The contact pin 12 has a first end 16, a second end 18, an upper surface 20 and a lower surface 22 and is quadrangular in cross-section, and in a preferred mode is square in cross-section.

The terminal 24 has a first section 26 and a second section 28 spaced therefrom. The first section 26 has a pair of jaws 30, 32, in crimping engagement with the upper contact surface 20. The jaws are attached to a band or ribbon 34 that is in contact with the lower surface 22 of the contact pin 12.

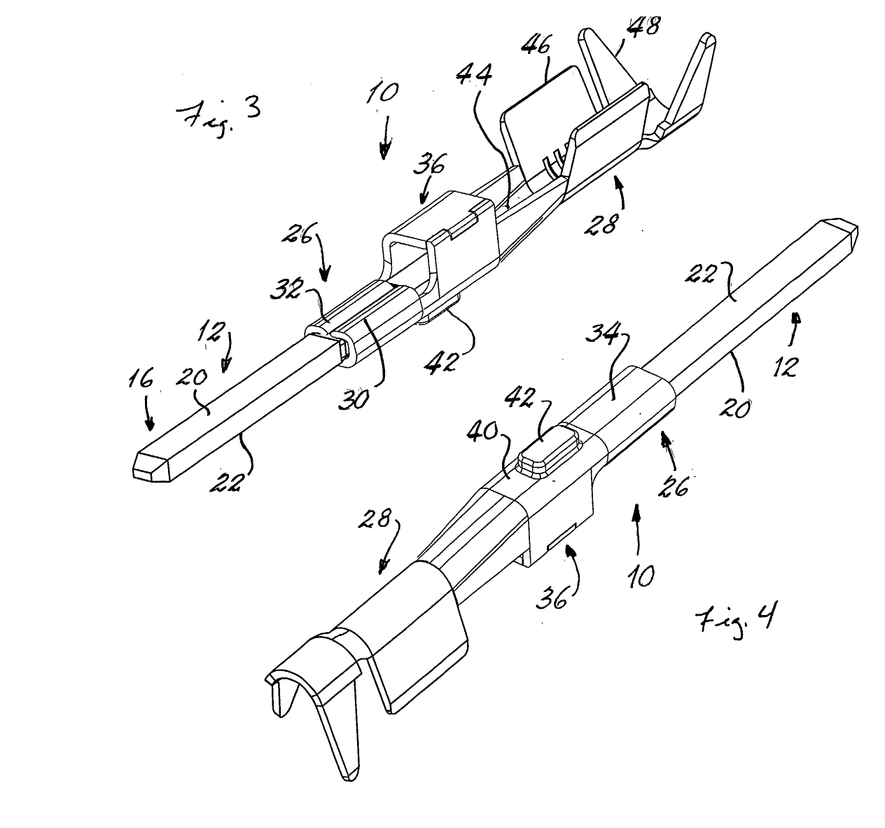

A box structure 36 is positioned between the first section 26 and the second section 28 and has an upper surface area 38 and a lower surface area 40. A polarizing key 42 is formed in the lower surface area 40, as by stamping. In the embodiment shown in FIGS. 1 and 2 the polarizing key 42 is asymmetrically located with respect to the longitudinal axis 14. In the embodiment shown in FIGS. 3 and 4 the polarizing key 42 is centrally located with respect to the longitudinal axis 14.

The second section 28 is formed to receive a wire or cable (not shown) and comprises a wire receiving trough 44 and two pairs of wings, 46 and 48 respectively. The first pair of wings 46 is employed for clamping an exposed, electrically conductive portion of the wire or cable and the second pair of wings 48 is employed for clamping the insulated portion of the wire, thereby securely fastening the wire to the terminal and making electrical connection thereto.

Referring specifically to FIGS. 3 and 4, the elongated contact pin 12 is rectangular and the polarizing key 42 is centrally located with respect to the longitudinal axis 14. In other respects the contacts of FIGS. 1 and 3 are identical.

There is therefore provided by this invention a two-piece male electrical contact that has a reduced length with concomitant cost savings in both material and manufacture.

While there have been shown and described what are at present considered the preferred embodiments of the invention, it will be apparent to those skilled in the art that various changes and modifications can be made herein without departing from the scope of the invention as defined by the appended claims.

What is claimed is:

1. A male contact comprising:
an elongated contact pin having a longitudinal axis and a first end and a second end, and an upper surface and a lower surface;
an elongated terminal extending along said longitudinal axis and having a first section attached to said contact pin and a second section spaced therefrom, said first section having a pair of jaws in engagement with said contact upper surface and a band or ribbon in engagement with said contact lower surface;
a box structure between said first and second sections, said box structure having an upper surface area and a lower surface area; and
a polarizing key formed in said lower surface area.

2. The male contact of claim 1 wherein said elongated contact is quadrangular in cross-section.

3. The male contact of claim 2 wherein said elongated contact is square in cross-section.

4. The male contact of claim 1 wherein said polarizing key is asymmetrically located with regard to a centerline of said box structure lower surface.

5. The male contact of claim 1 wherein said polarizing key is located on the centerline of said box structure lower surface.
